(19) United States
(12) Patent Application Publication
(10) Pub. No.: US 2011/0235534 A1
(43) Pub. Date: Sep. 29, 2011

(54) UPLINK ACK/NACK SIGNALING FOR AGGREGATED CARRIERS IN A COMMUNICATION NETWORK

(75) Inventors: Rapeepat Ratasuk, Hoffman Estates, IL (US); Weidong Yang, Hoffman Estates, IL (US)

(73) Assignee: MOTOROLA, INC., Libertyville, IL (US)

(21) Appl. No.: 12/972,877

(22) Filed: Dec. 20, 2010

Related U.S. Application Data
(60) Provisional application No. 61/316,402, filed on Mar. 23, 2010.

(51) Int. Cl. H04L 12/26; H04W 72/04

(52) U.S. Cl. 370/252; 370/329

(57) ABSTRACT

A system and method for uplink ACK/NACK signaling for aggregated carriers in a communication network includes a step 400 of determining that a user equipment-specific configuration consists of at least two aggregated downlink carriers. A next step 402 includes instructing the user equipment to provide ACK/NACK feedback. A next step 404 includes receiving ACK/NACK feedback.

### TECHNICAL FIELD OF THE INVENTION

This invention relates generally to wireless communication systems and more particularly to uplink ACK/NACK signaling in a communication network.

### BACKGROUND OF THE INVENTION

In the proposed Long Term Evolution Advanced (LTE-A) system, multiple component carriers can be aggregated together for downlink (DL) and uplink (UL) messages. Up to five DL carriers can be aggregated together along with a lesser number of UL carriers, e.g. one or two. However, a problem arises in that lesser number of UL carriers do not have enough resources to transmit the DL Acknowledge or Negative Acknowledge (ACK/NACK) messages for these greater number of DL component carriers. In the worst case scenario, ACK/NACK messages for five DL carriers must be supported on one UL carrier. Therefore, it has been agreed that a single UE-specific uplink component carrier will be configured semi-statically to carry the ACK/NACK messages independent of how many downlink component carriers were configured. This means that sending simultaneous ACK/NACK messages from a single UE on multiple carriers is not supported.

Referring to FIG. 1, in the proposed LTE-A system, carrier aggregation has specific user equipment (UE) configurations. Four agreed-upon examples of UE-specific configurations are shown. Configuration 2 is an example of a UE-specific configuration for system-specific configuration of five DL carriers and two UL carriers.

Several potential solutions for ACK/NACK transmission under carrier aggregation have been proposed. These solutions include; bundling, resource (code) selection. multi-code transmission, spreading-factor reduction, and higher-order modulation, as are known in the art. Each method has advantages and drawbacks, and performs well under different scenarios. For example, resource selection works well when the number of ACK/NACK is small, but requires substantial resources for a large number of bits. Bundling is good when error events are likely to be correlated, but results in poor performance when they are not. As a result, different methods are presently needed to support different carrier aggregation configurations. For instance, resource selection can be reused when two or three carriers are assigned, but for four to five carriers, a different method is needed.

What is needed is a technique for handling ACK/NACK in the case of carrier aggregation in the LTE-Advanced communication network. In particular, it would be beneficial to provide an efficient method for UL ACK/NACK signaling with low overhead that will work regardless of UE-specific configuration. It would also be of benefit to provide an approach that is compatible with legacy communication systems.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates block diagrams of four different UE-specific configurations for an LTE-A system;

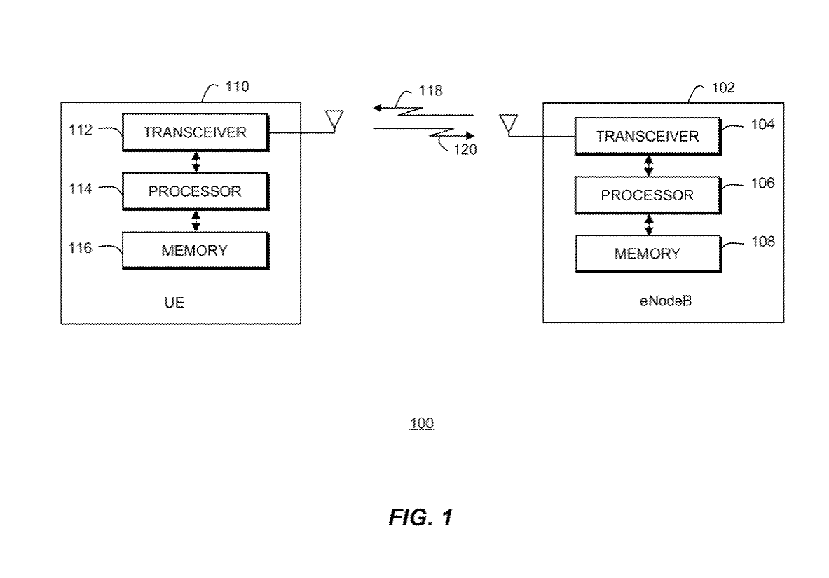

FIG. 2 is a block diagram of a system, in accordance with the present invention;

FIG. 3 is a graphical representation of the improvement provided by the present invention; and

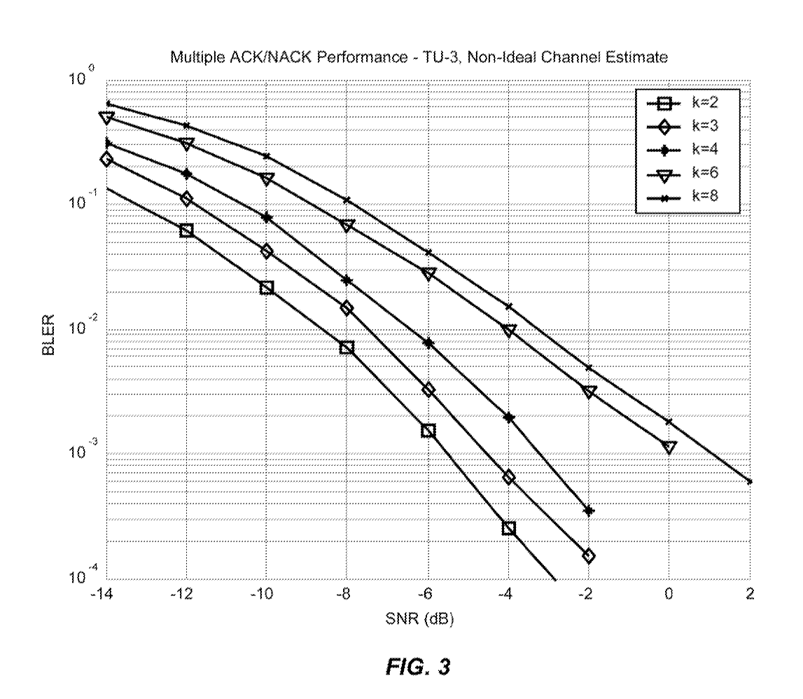

FIG. 4 illustrates a flow chart for a method, in accordance with the present invention.

Skilled artisans will appreciate that common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENT

The present invention provides a technique for handling ACK/NACK in the case of carrier aggregation in the LTE-Advanced communication network. In particular, the present invention provides an efficient method for UL ACK/NACK signaling with low overhead that will work regardless of UE-specific configuration. The present invention also provides an approach that is compatible with legacy communication systems.

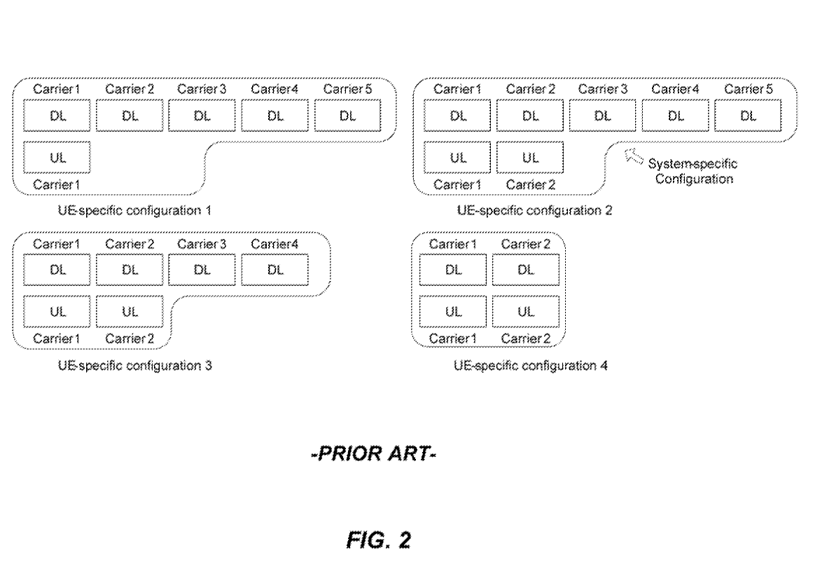

FIG. 2 is a simplified block diagram depiction of an LTE-A wireless communication system 100, in accordance with the present invention. However, it should be recognized that the present invention is also applicable to other OFDMA systems such as IEEE 802.xx-based systems, employing wireless technologies such as IEEE's 802.11, 802.16, or 802.20, modified to implement embodiments of the present invention. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for such wireless telecommunications systems.

Referring to FIG. 2, there is shown a simplified block diagram of an evolved NodeB (eNodeB) 102 in communication with one or more UE 110. Those skilled in the art will recognize that FIG. 2 does not depict all of the network equipment necessary for system to operate but only those system components and logical entities particularly relevant to the description of embodiments herein. For example, an eNodeB, access point, or base station can comprise one or more devices such as wireless area network stations (which include access nodes (ANs), Media Access Controllers (MAC), AP controllers, and/or switches), base transceiver stations (BTSs), base site controllers (BSCs) (which include selection and distribution units (SDUs)), packet control functions (PCFs), packet control units (PCUs), and/or radio network controllers (RNCs). In addition, user equipment (UE) or remote unit platforms are known to refer to a wide variety of consumer electronic platforms such as, but not limited to, mobile stations, subscriber equipment, mobile nodes, access terminals, terminal equipment, gaming devices, personal computers, and personal digital assistants, all referred to herein as UE. However, none of these other devices are specifically shown in FIG. 2.

The eNodeB 102 comprises a processor 106 coupled to a transceiver 104 and memory 108. UE 110 also comprises a processor 114 coupled to a transceiver 112 and memory 116. The transceivers of each can be connected to one or more antennas (one shown). In general, components such as processors and transceivers are well-known. For example, processing units are known to comprise basic components such as, but not limited to, microprocessors, microcontrollers, digital signal processors (DSPs), memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, and/or a protocol specification, those skilled in the art are aware of the many design and development techniques available to implement a processor that performs the given logic. Therefore, eNodeB 102 and UE 110 both represent a known apparatus that has been adapted, in accordance with the description herein, to implement various embodiments of the present invention. The eNodeB 102 and UE 110 use a wireless interface for communication. The wireless interface corresponds to an uplink 120 and downlink 118, each comprising a group of channels and subchannels used in the implementation of various embodiments of the present invention.

Each UE 110 is required to provide respectively uplink signals 120 to the eNodeB 102 indicating whether downlink signals 118 from the eNodeB 102 have been properly received or not, i.e. Acknowledge or Negative Acknowledge (ACK/NACK) messages, respectively. As stated above, in the case of aggregated carriers, a problem arises when there are not enough uplink resources to report on an aggregation of downlink carriers. Currently, ACK/NACK resource allocation is done implicitly based on the control channel element (CCE) assignment. However, to support implicit selection with carrier aggregation may require extensive amount of resources to be reserved. This overhead may be substantial considering (a) the need to support different user-specific carrier configurations, and (b) the number of scheduled users with assignment in multiple carriers may be limited. Where there are only two to three aggregated downlink carriers, the uplink carrier has enough resources to use code selection to provide ACK/NACK feedback, as is presently done for Time Division Duplex (TDD) systems. However, the uplink payload size for one uplink carrier needed for ACK/NACK signals for four to five aggregated downlink carriers can be substantial (up to twelve bits).

The present invention proposed to use physical uplink control channel (PUCCH) Format 2 (CQI) channel coding to provide ACK/NACK signals for multiple downlink carriers. It should be noted that when PUCCH Format 2 is used for this purpose, control channel resource may be reserved exclusively for this purpose to provide a dedicated resource for the ACK/NACK signals. Currently, (PUCCH) Format 2 channel coding can support up to thirteen bits, more than sufficient for the up to twelve bits needed for five aggregated downlink carriers. In addition, (PUCCH) Format 2 channel coding can be easily expanded to support more than thirteen bits. Performance is also robust. This is because deployment planning must ensure that the user can at least support reliable wideband CQI (4-bit) reporting mode. As a result, and in accordance with the present invention, PUCCH Format 2 can also be extended for uplink ACK/NACK transmission for downlink carrier aggregation. This provides a solution that is compatible to LTE Release-8 specification and thus can be supported with no impact to legacy users. In addition, this same concept can be used when acknowledgements are multiplexed on the physical uplink shared channel (PUSCH). Currently, up to five downlink carriers may be aggregated. The UE is given downlink data assignment on each carrier using an assignment grant. In LTE, the assignment grant is given via the Downlink Control Information which is carried on the Physical Downlink Control Channel (PDCCH). A separate assignment grant will be given for each carrier, thus up to five assignment grants may be given in the same subframe. This concept can be extended to support more carriers in the future under the same framework. Techniques such as ACK/NACK repetition or interference management can also be used to extend coverage. SR (Scheduling Request) can be also multiplexed with Uplink ACK/NACK under some scenarios.

Of course the eNodeB must instruct the UE to use the format of PUCCH Format 2 channel quality index (CQI) coding for its ACK/NACK feedback. In particular, the UE is instructed on its ACK/NACK resource assignment as to when it should use the CQI format to provide ACK/NACK signaling and at what particular carrier index. To reduce overhead, the present invention also envisions a technique where ACK/NACK resource assignment can be given explicitly or implicitly in a grant, or a hybrid approach using elements of both. Explicit instructions have the advantage of reserving only those UL resources needed for the UE to provide its ACK/NACK feedback, at the expense of the eNodeB sending the detailed explicit assignment instructions on the DL, which require larger overhead. Implicit instructions have the advantage of using less detailed assignment instructions (and therefore less overhead) on the downlink, at the expense of reserving more UL resources, inasmuch as the eNodeB will not know exactly when the UE will send its ACK/NACK feedback. A hybrid approach is used to balance the UL and DL resources to minimize overhead.

The present invention considers several implicit resource selection schemes to reduce overhead. Firstly, the assignment can be based on a number of fields given/used in the DL grant as such CCE, scheduled carriers, etc. (e.g. user uses the lowest CCE number of the lowest DL carrier number). Secondly, the assignment can be based on a user-specific carrier aggregation configuration (e.g. user with 2DL-1UL configuration transmits ACK/NACK on specific PUCCH zone). Thirdly, the UE can select its UL resource based on a predefined Cell Radio Network Temporary ID (C-RNTI) relationship.

The present invention considers several explicit resource selection schemes to reduce overhead. However, it should be noted that explicit scheduling is suitable only for small number of UEs with assignment in multiple carriers, and may require an additional field in the downlink assignment. In this case, overhead saving versus flexibility should be considered. A first example of explicit resource assignment includes UEs being given the resource assignment via a field in the DL grant. Secondly, resource assignment can be given via Cyclic Redundancy Check (CRC) masking—where the resource selection is indicated by different masking bit patterns, where each pattern corresponds to a different carrier index. Thirdly, UEs can be assigned resources (e.g. PUCCH resource index and uplink carrier) via radio resource controller (RRC) signaling ahead of time, where the eNodeB manages scheduling to ensure there is no resource conflict.

The present invention also considers a hybrid approach to downlink ACK/NACK resource assignment, which can further reduce PUCCH overhead while managing conflicts. In this case, ACK/NACK resource assignment is done implicitly in principle but with possible explicit control by the eNodeB (e.g. to avoid resource conflict). This is analogous to the physical hybrid ARQ indicator channel (PHICH) resource assignment where an ACK/NACK resource is implicitly tied to the resource block number but can also be explicitly controlled by eNodeB using demodulation reference signal (DMRS) assignment. With this approach, it could be possible to reduce the PUCCH overhead substantially. Other hybrid approaches are also possible. For example, an ACK/NACK resource can be implicitly tied to the CCE number but can also be explicitly changed by the eNodeB using an explicit assignment field (e.g. number of scheduled carriers). With this approach, it is possible to reduce the PUCCH overhead substantially since eNB can avoid potential resource contention.

### EXAMPLE

Simulation data show that the present invention provides an improvement over the prior art. To evaluate performance of the proposed technique of the present invention, simulations have been conducted for five DL carriers in PUCCH Format 2 (CQI) using the following parameters, Block Error Rate (BLER) is evaluated for different number of ACK/NACK information bits to be transmitted, and the transmit power of the UE is varied to evaluate performance at different Signal-to-Noise (SNR) values. The value of k represents the number of different ACK/NACK bits being transmitted using PUCCH Format 2, and was increased for different simulations.

The results are represented as Block Error Rate (BLER) versus Signal-to-Noise Ratio (SNR). As can be seen for an increase in k, the BLER is reduced for a given SNR. It should be noted that users should be able to support at least 4-bit feedback on the PUCCH since this is the wideband CQI feedback mode. In addition, the present invention could be extended to 10-12 bits without requiring a substantial increase in power. However, ACK/NACK repetition or interference management can be used to extend coverage if necessary.

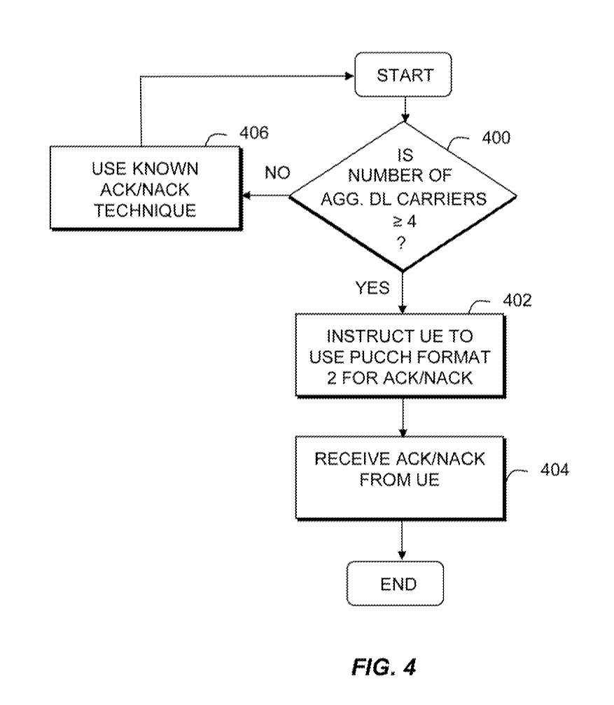

Referring to FIG. 4, the present invention also provides a method for uplink control signaling in a communication system, in accordance with a third embodiment of the present invention. The method includes a first step 400 of determining that a user equipment-specific configuration consists of at least two aggregated downlink carriers. If the UE is configured for only one downlink carrier, then prior art ACK/NACK techniques can be used 406.

A next step 402 includes instructing the user equipment to provide ACK/NACK feedback on an uplink resource, such as using physical uplink control channel (PUCCH) Format 2 channel coding to provide ACK/NACK feedback. Optionally, the uplink resource in the instructing step includes the uplink carrier index and the ACK/NACK resource index. The actual assignments are determined by the eNodeB processor and stored in memory. The processor instructs the eNodeB transceiver to send information regarding the actual assignments for the UE.

In a first embodiment, the uplink resource assignment to be used by the UE for the ACK/NACK response can be based on a number of fields given/used in one or more DL grant as such CCE, scheduled carriers, etc. (e.g. user uses the lowest CCE number of the lowest DL carrier number).

In a second embodiment, the uplink resource assignment can be based on a user-specific carrier aggregation configuration (e.g. user with 2DL-1UL configuration transmits ACK/NACK on specific PUCCH zone). Alternately, the UE may apply different offset to its ACK/NACK resource selection based on the user-specific carrier aggregation. For example, user with 2DL-1UL configuration may offset its ACK/NACK resource selection by two times a preconfigured number, whereas user with 5DL-1UL configuration may offset its ACK/NACK resource selection by five times a preconfigured number.

In a third embodiment, the UE selects its UL resource based on a predefined Cell Radio Network Temporary ID (C-RNTI) relationship or some other temporary identity for resolving resource mapping conflict. For example, the eNB may first preconfigured M existing ACK/NACK resource indices. UE then selects its ACK/NACK based on a predefined relationship between its C-RNTI and the existing resource indices. One example of this relationship would be to select the ACK/NACK resource index according to ACK/NACK Index=C-RNTI modulo M. Another example is a hash function is used to generate the mapping. In a properly implemented eNB, any possible conflict of resource mapping from multiple UEs is checked at the eNB side and handled accordingly.

In a fourth embodiment, an ACK/NACK resource index assignment can be based on information in one or more fields in one or more DL assignment grants. This may be done implicitly or explicitly. For example, the UE may use its resource block allocation, modulation and coding, or carrier index to implicitly determine its ACK/NACK resource index. Alternately, an explicit resource index field may be added to the DL grant. Alternately, an unused value in one of the field can be reused to inform the UE of its uplink resource assignment. Additionally, since the UE can receive many grants, the ACK/NACK resource index can be derived by combining information fields from the multiple downlink grants.

In a fifth embodiment, the uplink resource assignment can be based on Cyclic Redundancy Check (CRC) masking on the downlink control channel—where the uplink resource selection is indicated by different masking bit patterns, where each pattern corresponds to a different ACK/NACK resource index. For example, P different masking bit patterns may be defined. The eNB then informs the UE of its ACK/NACK resource index by masking the CRC bits on the downlink data assignment given in the PDCCH with one of the P different masking bit patterns. Note that the same masking bit pattern must be used on all the downlink assignment grants.

In a sixth embodiment, the uplink resource assignment can be based on UEs being assigned resources (e.g. PUCCH resource index and uplink carrier) via radio resource controller (RRC) signaling ahead of time, where the eNodeB manages scheduling to ensure there is no resource conflict. In this case, ACK/NACK resource index for a UE is predefined and eNB must ensure that there is no resource conflict among scheduled users. In case of conflict, however, a field in the downlink grant may be used to reassign the UE to a different resource.

In a seventh embodiment, the uplink resource assignment is based on a channel control element number. This could be based, for example, on the control channel element number corresponding to one of the downlink assignment grant. Alternatively, it may be based on a combination of control channel element numbers from the different grant. Optionally, the uplink resource assignment is subsequently changed. Preferably, this change is based on an explicit assignment field instruction to the UE from the eNodeB.

A next step 404 includes receiving ACK/NACK feedback from the UE, such as in PUCCH Format 2 channel coding from the UE.

It will be understood that the terms and expressions used herein have the ordinary meaning as is accorded to such terms and expressions by persons skilled in the field of the invention as set forth above except where specific meanings have otherwise been set forth herein.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including use of hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

While the invention may be susceptible to various modifications and alternative forms, a specific embodiment has been shown by way of example in the drawings and has been described in detail herein. However, it should be understood that the invention is not intended to be limited to the particular forms disclosed, and can be applied equally well to any communication system that can use real-time services. Rather, the invention is to cover all modification, equivalents and alternatives falling within the scope of the invention as defined by the following appended claims.

What is claimed is:

1. A method for controlling uplink Acknowledged/Negative Acknowledged (ACK/NACK) signaling for aggregated carriers in a communication network, the method comprising the step of:
determining that a user equipment-specific configuration consists of at least two aggregated downlink carriers;
instructing the user equipment to provide ACK/NACK feedback on an uplink resource; and
receiving ACK/NACK feedback.

2. The method of claim 1, wherein the instructing step includes instructing the user equipment to use physical uplink control channel (PUCCH) Format 2 channel coding to provide ACK/NACK feedback.

3. The method of claim 1, wherein the receiving step includes receiving ACK/NACK feedback in PUCCH Format 2 channel coding.

4. The method of claim 1, wherein the uplink resource in the instructing step includes the uplink carrier index and the ACK/NACK resource index.

5. The method of claim 1, wherein the instructing step includes basing the uplink resource assignment on a number of fields given in one or more downlink grants to the UE.

6. The method of claim 1, wherein the instructing step includes basing the uplink resource assignment on a user equipment-specific carrier aggregation configuration.

7. The method of claim 1, wherein the instructing step includes selecting an uplink resource based on a predefined Cell Radio Network Temporary ID (C-RNTI) relationship.

8. The method of claim 1, wherein the instructing step includes basing an ACK/NACK resource index assignment on information in one or more fields in one or more downlink assignment grants.

9. The method of claim 1, wherein the instructing step includes basing the uplink resource assignment on Cyclic Redundancy Check masking, where the uplink resource selection is indicated by different masking bit patterns.

10. The method of claim 1, wherein the instructing step includes basing the uplink resource assignment on resources assigned via a radio resource controller.

11. The method of claim 1, wherein the instructing step includes basing the uplink resource assignment on a channel control element number.

12. The method of claim 1, wherein the instructing step subsequently includes a substep of changing a given uplink resource assignment.

13. The method of claim 12, wherein the changing substep is based on an explicit assignment field instruction.

14. An eNodeB operable to control uplink ACK/NACK signaling for aggregated carriers in a communication network, the eNodeB comprising:
a processor operable to determine that a user equipment-specific configuration consists of at least two aggregated downlink carriers; and
a transceiver for receiving instructions from to the processor and a memory, the transceiver operable to send information instructing user equipment to provide ACK/NACK feedback, and to receive such feedback.
